(19) United States
(12) Patent Application Publication
(10) Pub. No.: US 2014/0050621 A1
(43) Pub. Date: Feb. 20, 2014

(54) BIOSENSOR AND BIOMATERIAL DETECTION APPARATUS INCLUDING THE SAME

(71) Applicant: Electronics and Telecommunications Research Institute, Daejeon (KR)

(72) Inventors: Han Young YU, Daejeon (KR); Yong Sun YOON, Daejeon (KR); Yark Yeon KIM, Daejeon (KR); Won Ick JANG, Daejeon (KR); Eun-ju JEONG, Daejeon (KR); Ji Eun LIM, Daejeon (KR)

(21) Appl. No.: 13/918,823

(22) Filed: Jun. 14, 2013

(30) Foreign Application Priority Data
Aug. 14, 2012 (KR) 10-2012-0089057
Mar. 7, 2013 (KR) 10-2013-0024629

(51) Int. Cl. G01N 30/00

(52) U.S. Cl. CPC G01N 30/00
USPC 422/69

(57) ABSTRACT

Provided are a biosensor and a biomaterial detection apparatus including the same. The biomaterial detection apparatus comprises a light source to provide quantized photons; a substrate spaced apart from the light source; a single photonic sensor layer disposed on the substrate to sense the photons; and an adsorption layer disposed to cover the single photonic sensor layer, allow the photons to pass therethrough, and adsorb a biomaterial between the light source and the substrate.

### CROSS-REFERENCE TO RELATED APPLICATIONS

This US non-provisional patent application claims priority under 35 USC §119 to Korean Patent Application Nos. 10-2012-0089057, filed on Aug. 14, 2012, and 10-2013-0024629, filed on Mar. 7, 2013, the entirety of which is hereby incorporated by reference.

### BACKGROUND OF THE INVENTION

Exemplary embodiments of inventive concepts relate to sensors and detection apparatuses including the same and, more particularly, to a biosensor and a biomaterial detection apparatus including the same.

In general, a method for implementing a biosensor using a light source requires large light intensity. Since variation of the light intensity is small when a biomaterial is combined with a fixed biomaterial, there is little variation of the light intensity as compared to the total light intensity. Therefore, it is difficult to implement a technique for sensing biomaterials with the operation of an optical sensor. Accordingly, techniques for sensing biomaterials have been proposed to overcome the disadvantage. One of the techniques is that a resonant reflection optical sensor of fine structure is formed like a resonant reflection optical biosensor and a biomaterial is detected by measuring a resonant frequency varying depending on variation in dielectric constant of a resonant reflection light when the biomaterial is adsorbed on the filter. That is, a sensor technique for sensing biomaterials through large light intensity suffers from many difficulties in implementation and operation. A biosensor exhibits a low sensitivity and a low dynamic range due to a low signal-to-noise ratio (SNR) when sensed light intensity is small as compared to the total light intensity of light provided from a light source. For this reason, utilization of the biosensor is extremely limited as a sensor. Accordingly, there is a need for a high-sensitivity biosensor having a high sensitivity to sense a small amount of biomaterials and a wide dynamic range.

### SUMMARY OF THE INVENTION

Exemplary embodiments of inventive concepts provide a biosensor and a biomaterial detection apparatus including the same.

A biomaterial detection apparatus according to an embodiment of the inventive concept may include a light source providing quantized photons; a substrate spaced apart from the light source; a single photonic sensor layer disposed on the substrate to sense the photons; and an adsorption layer covering the single photonic sensor layer, allowing the photons to pass therethrough, and adsorbing a biomaterial between the light source and the substrate.

In an exemplary embodiment, the single photonic sensor layer may include an avalanche photodiode or a silicon photomultiplier.

In an exemplary embodiment, the adsorption layer may include silicon or silicon oxide.

In an exemplary embodiment, the adsorption layer may include at least one of glass, quartz, silicon nitride (Si₃N₄), germanium nitride (Ge₃N₄), aluminum oxide (Al₂O₃), aluminum sulfide (Al₂₅₃), gallium sulfide (Ga₂S₃), indium sulfide (In₂S₃), aluminum selenide (Al₂Se₃), gallium selenide (Ga₂Se₂), indium selenide (In₂Se₃), aluminum telluride (Al₂Te₃), gallium telluride (Ga₂Te₃), indium telluride (In₂Te₃), aluminum cobalt (Al₂CO), polycarbonate, poly(methyl methacrylate) (PMMA), and cyclic olefin copolymer (COC).

In another exemplary embodiment, the adsorption layer may include a DNA adsorption layer. The DNA adsorption layer may include a chemical reactor that is capable of binding a transparent adsorption layer and a biomaterial to each other. When DNA, i.e., the biomaterial is desired to be sensed, probe DNA fixed to an adsorption surface and introduced target DNA are complementarily bound to each other, and thus the biomaterial may act as a biosensor according to variation of the intensity of transmitted light. When protein, i.e., the biomaterial is desired to be sensed, an antibody fixed to an adsorption surface and an introduced antigen are complementarily bound to each other, and thus the biomaterial may act as a biosensor according to variation of the intensity of transmitted light.

In an exemplary embodiment, the adsorption layer may include a DNA adsorption layer. The DNA adsorption layer may include thiol, amine or silane.

In an exemplary embodiment, the photons of the light source may be controlled or modulated by an AC power source.

In an exemplary embodiment, the light source may include a light emitting diode (LED) or laser.

In another exemplary embodiment, the biomaterial detection apparatus may further include a controller configured to count the number and frequency of the photons using a sensing signal output from the single photonic sensor layer according to the amount of the photons.

In an exemplary embodiment, the substrate may include a semiconductor or a metal with conductivity. The substrate may have the same structure as the single photonic sensor layer.

A biosensor according to an exemplary embodiment of the inventive concept may include a substrate; a single photonic sensor layer disposed on the substrate to sense photons; and an adsorption layer covering the single photonic sensor layer, allowing the photons to pass therethrough, and adsorbing a biomaterial to the substrate.

In an exemplary embodiment, the adsorption layer may include silicon or silicon oxide.

In an exemplary embodiment, the adsorption layer may include at least one of glass, quartz, silicon nitride (Si₃N₄), germanium nitride (Ge₃N₄), aluminum oxide (Al₂O₃), aluminum sulfide (Al₂S₃), gallium sulfide (Ga₂S₃), indium sulfide (In₂S₃), aluminum selenide (Al₂Se₃), gallium selenide (Ga₂Se₂), indium selenide (In₂Se₃), aluminum telluride (Al₂Te₃), gallium telluride (Ga₂Te₃), indium telluride (In₂Te₃), aluminum cobalt (Al₂CO), polycarbonate, poly(methyl methacrylate) (PMMA), and cyclic olefin copolymer (COC).

In an exemplary embodiment, the adsorption layer may include a DNA adsorption layer.

In an exemplary embodiment, the DNA adsorption layer may include thiol, amine or silane.

### BRIEF DESCRIPTION OF THE DRAWINGS

Inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of inventive concepts.

FIG. 1 is a top plan view of a typical biosensor.

FIG. 2 shows a voltage-current graph of the biosensor in FIG. 1.

FIG. 3 shows a cross section of the biosensor in FIG. 1.

FIG. 4 shows a graph illustrating an optical reception signal obtained by the biosensor in FIG. 1.

FIG. 5 illustrates a biomaterial detection apparatus according to an embodiment of the inventive concept.

FIGS. 6A to 6C illustrate variation in the amount of a biomaterial adsorbed on a biomaterial detection apparatus according to the inventive concept.

FIGS. 7A to 7C show histograms depending on variation in the amount of the biomaterial in FIGS. 6A to 6C.

### DETAILED DESCRIPTION

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a”, “an”, and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

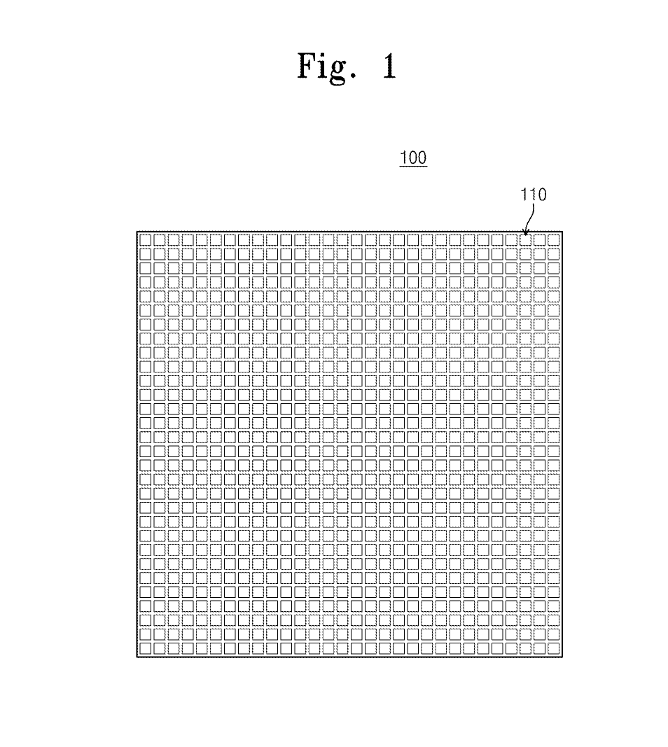

FIG. 1 is a top plan view of a typical biosensor 100. As illustrated, the biosensor 100 includes a plurality of unit cells 110 arranged in an array. Each of the unit cells 110 may sense externally irradiated light to output a sense signal. The light may include quantized photons (hν). The sense signal may be generated from an electron and a hole created in each of the unit cells 110. Each of the unit cells 110 may a silicon photomultiplier (SiPM) based on a silicon photodiode. If a photon is fired to any one of the unit cells 110, the overall array-type biosensor 100 may be used as an element capable of sensing a single light. On the other hand, a CMOS element and/or a CCD element cannot sense small number of photons (hν) including a single photon (hν). Therefore, the typical biosensor 100 may have higher optical reception sensitivity than the CMOS element or the CCD element.

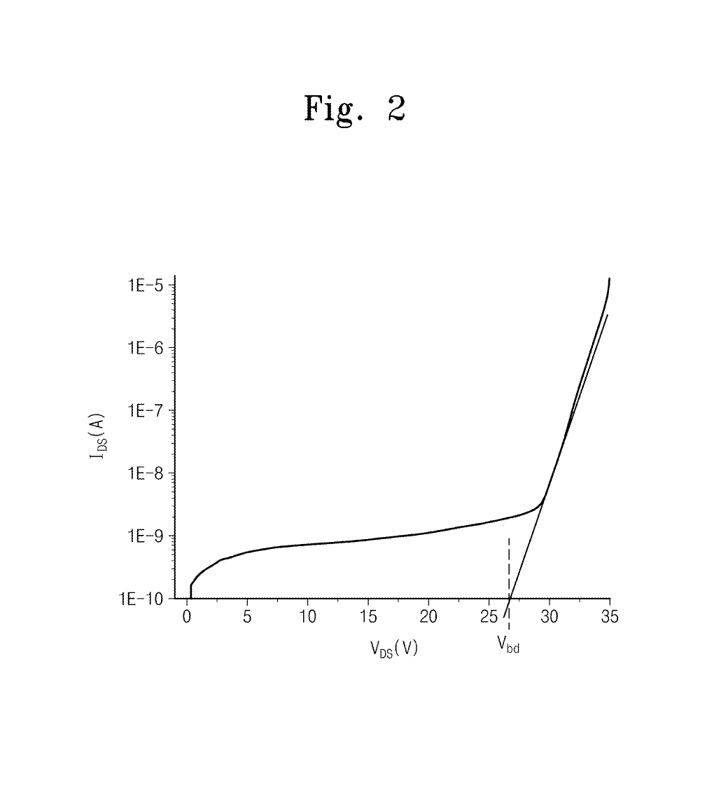

FIG. 2 shows a voltage-current graph of the biosensor in FIG. 1.

Referring to FIGS. 1 and 2, the biosensor 100 may operate at a higher voltage than a breakdown voltage V_{bd}. The breakdown voltage V_{bd} may be defined as a voltage at which when the magnitude of a reverse voltage applied to a PN junction such as a diode exceeds a certain limitation, avalanche occurs and thus large current flows. Increased current may improve reception sensitivity of the biosensor 100. The biosensor 100 may output current amplified by an operating voltage above the breakdown voltage V_{bd}. The biosensor 100 may also operate with a single photon hν and grasp even the number of the photons hν.

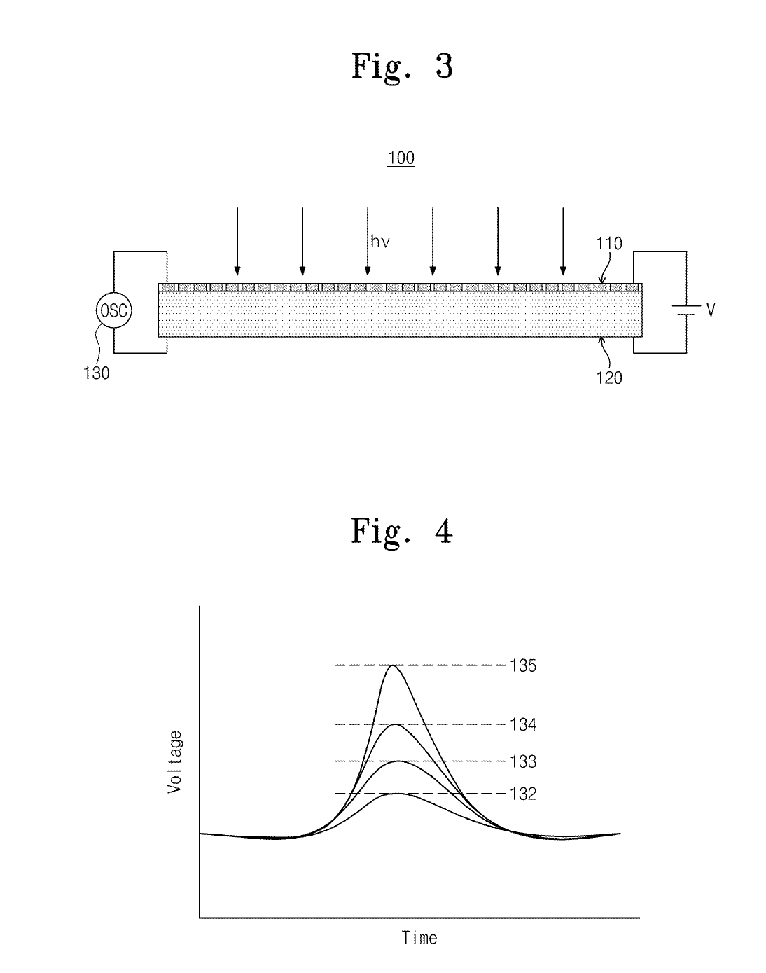

FIG. 3 shows a cross section of the biosensor 100 in FIG. 1.

Referring to FIG. 3, unit cells 100 of the biosensor 100 may be disposed on an electrode substrate 120. A bias voltage V may be supplied to one side of the unit cells 110 and the electrode substrate 120. The bias voltage V may be serially coupled between the unit cells 110 and the electrode substrate 120. The bias voltage V may be greater than a breakdown voltage. A signal detector 130 may be connected to the other side of the unit cells 110 and the electrode substrate 120. The signal detector 130 may include an oscilloscope.

FIG. 4 shows a graph illustrating an optical reception signal obtained by the biosensor 100 in FIG. 1.

Referring to FIGS. 3 and 4, the signal detector may obtain first to fourth voltages 132˜135 that sequentially increase in proportion to the number of photons hν. The first to fourth voltage 132˜135 may be quantized to be displayed. A bias voltage V for light source modulation may be an AC power source. The signal detector 130 may receive a trigger signal having the same frequency as a bias voltage V of AC to output a quantized voltage signal. For example, when a signal photon hν is sensed by the biosensor 100, the signal detector 130 may output a first voltage 132. When two photons hν are sensed at unit cells 110, the signal detector 130 may output a second voltage 133 higher than the first voltage 132. Similarly, when three and four photons hν are sensed by the biosensor 100, the signal detector 130 may output a third voltage 134 and a fourth voltage 135, respectively. Thus, a controller (not shown) may determine the number of photons hν sensed by the biosensor 100 depending on the intensity of a voltage signal of the signal detector 130. The intensity of the voltage signal may be displayed in proportion to the number of photons hν. The number of photons hν may be measured depending on the intensity of the voltage signal.

After describing a biomaterial detection apparatus according to an embodiment of the inventive concept, the number of photons hν depending on the amount of a biomaterial will be explained hereinafter.

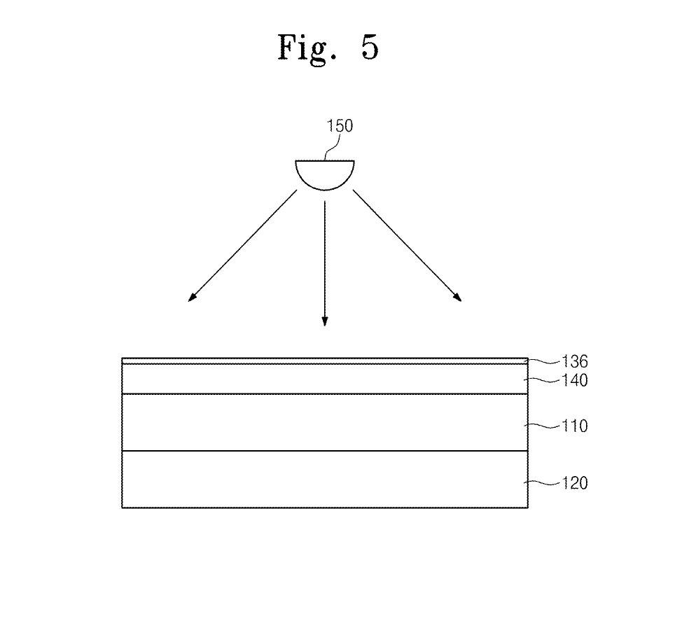

FIG. 5 illustrates a biomaterial detection apparatus according to an embodiment of the inventive concept.

Referring to FIG. 5, a biomaterial detection apparatus according to the inventive concept may include a light source 150, an electrode substrate 120, unit cells 110, and an adsorption layer 140. The light source 150 may be modulated to an AC light source or a DC light source and provide quantized photons hν. The electrode substrate 120 may include a semiconductor or a metal with conductivity. The unit cells 110 may be disposed on the electrode substrate 120 in the form of array. The unit cells 110 may include a single photonic sensor layer such as an avalanche photodiode or silicon photomultiplier.

The adsorption layer 140 may cover the unit cells 110. A biomaterial 136 between the light source 150 and the adsorption layer 140 may adsorb and reflect photons hν. The photons hν is not adsorbed to the adsorption layer 140 and may pass through the adsorption layer 140. The unit cells 110 may sense photons hν. The adsorption layer 140 may adsorb the biomaterial 136. The biomaterial 136 may include DNA having probe DNA that can be complementarily bound to the adsorption layer 140. In addition, the biomaterial 136 may include antibody protein which makes an antibody-antigen reaction with the adsorption layer 140 possible. The adsorption layer 140 may be preferentially bound to probe DNA of DNA and an antibody of protein. The adsorption layer 140 may include organic and inorganic substances bound and/or reacting to the biomaterial 136. For example, the adsorption layer 140 may include at least one of silicon (Si), silicon oxide (SiO₂), glass, quartz, silicon nitride (Si₃N₄), germanium nitride (Ge₃N₄), aluminum oxide (Al₂O₃), aluminum sulfide (Al₂S₃), gallium sulfide (Ga₂S₃), indium sulfide (In₂₅₃), aluminum selenide (Al₂Se₃), gallium selenide (Ga₂Se₂), indium selenide (In₂Se₃), aluminum telluride (Al₂Te₃), gallium telluride (Ga₂Te₃), indium telluride (In₂Te₃), aluminum cobalt (Al₂CO), polycarbonate, poly(methyl methacrylate) (PMMA), and cyclic olefin copolymer (COC). The biomaterial 136 may remain or be removed after reacting to the adsorption layer 140.

The adsorption layer 140 may form a reactor through surface immobilization. The adsorption layer 140 may be a transparent layer through which light may pass. A surface material of the adsorption layer 140 may appear to the reactor by bonding of a biomaterial. The reactor may react to a fixer bound to reactive DNA and a reactive antibody. A final biomaterial on the adsorption layer 140 may be probe DNA and a probe antibody. The adsorption layer 140 may include thiol, amine or silane. The adsorption layer 140 may be sensing DNA or a sensing material. Sensing target (or complementary target) DNA or a sensing target antigen may be bound to the sensing DNA or the sensing material. A resultant material may be a reactor, probe DNA or a probe antibody. The reactor, the probe DNA or the probe antibody may absorb and reflect light. The target DNA and the antigen may absorb and reflect light. The absorption and reflection of light may provide change in the intensity of the light to an optical sensor.

Although not shown, a controller may check the amount of photons hν from a voltage signal of the unit cells 110 to determine the amount of the biomaterial 136.

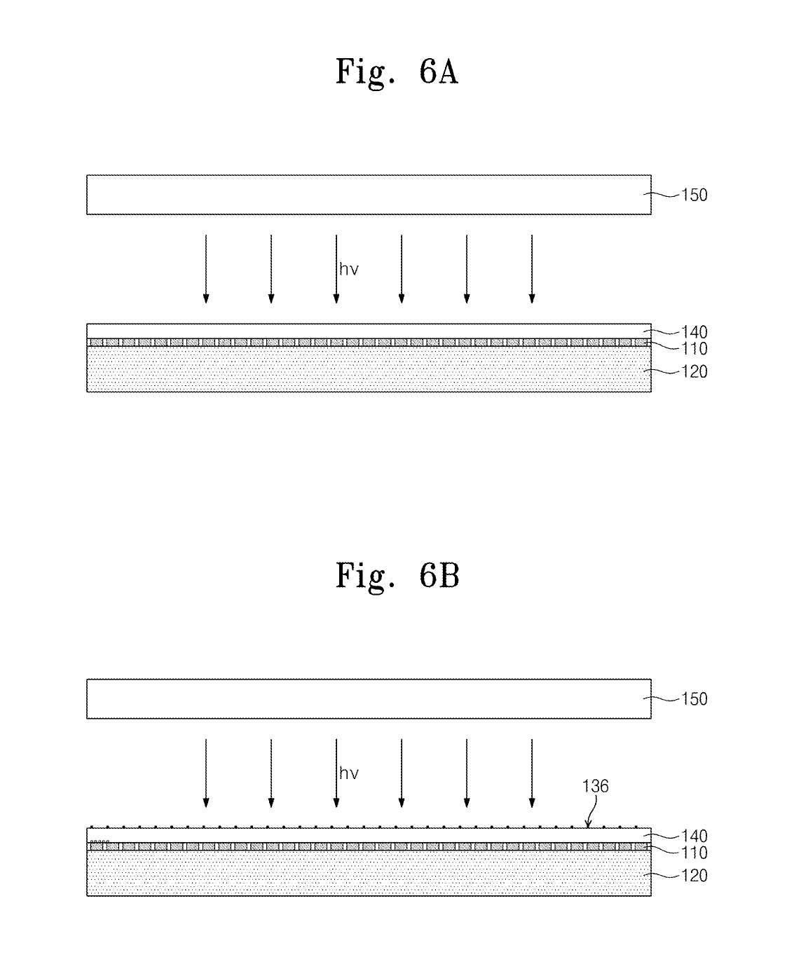

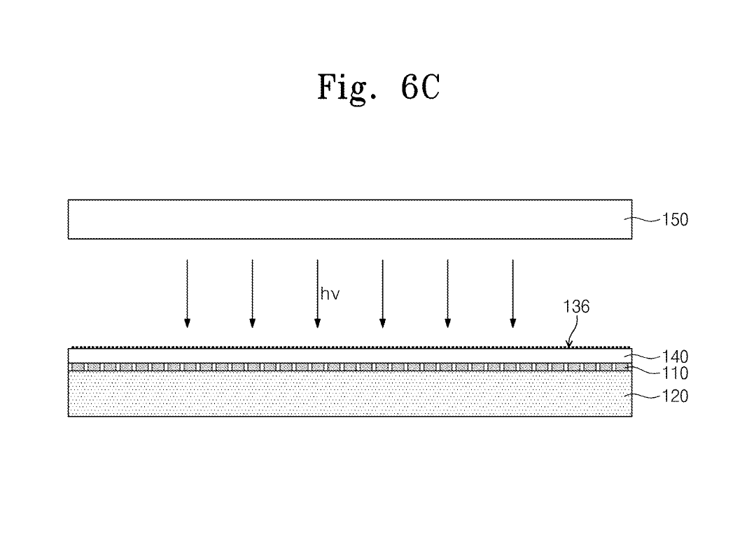

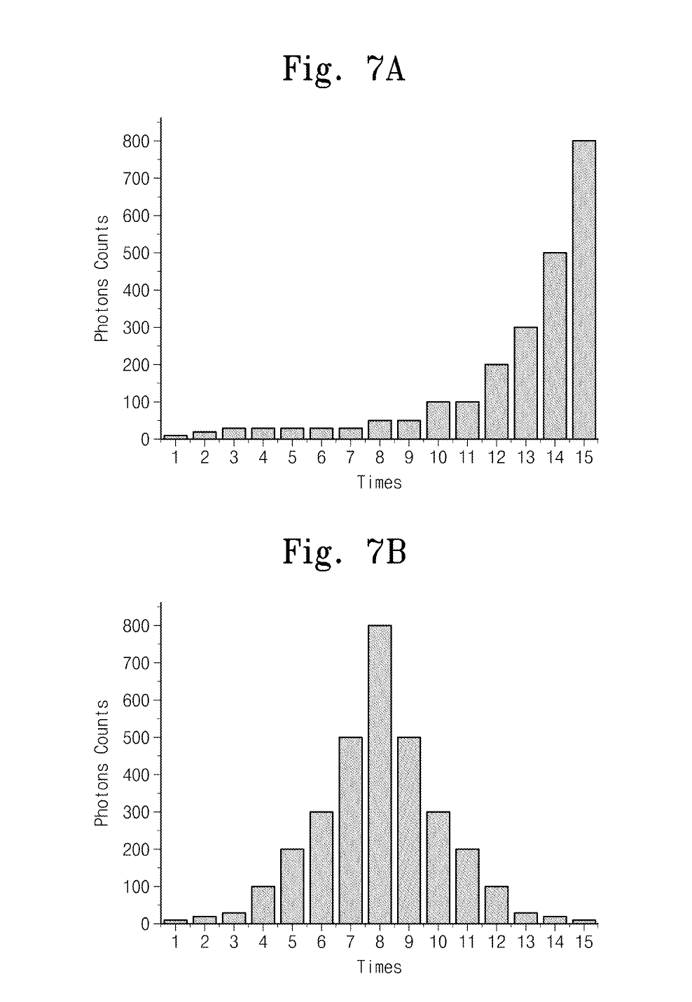

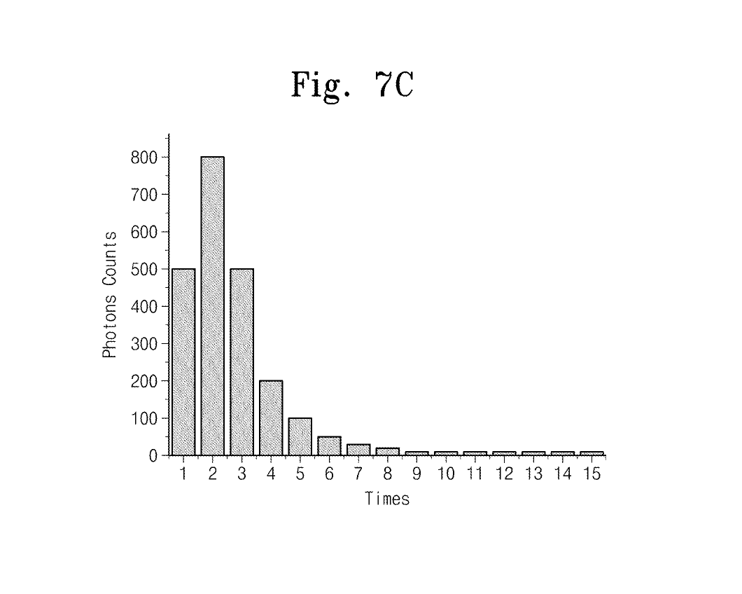

FIGS. 6A to 6C illustrate variation in the amount of a biomaterial 136 adsorbed on a biomaterial detection apparatus according to the inventive concept. FIGS. 7A to 7C show histograms depending on variation in the amount of the biomaterial 136 in FIGS. 6A to 6C.

Referring to FIGS. 6A and 7A, when a biomaterial adsorbed to an adsorption layer 140 is low, unit cells 110 may sense a number of photons hν. When extremely small amount of a biomaterial desired to be sensed is bound to the biomaterial 136 adsorbed to the adsorption layer 140, the unit cells 110 may sense a great number of photons hν. At this point, the biomaterial may be measured in a fluid or dried state. Binding of biomaterials may is introduced through a microfluidic channel. The binding of biomaterials may be fixed using a pipette without flow. The histogram in FIG. 7A may correspond to the number of the photons hν.

Referring to FIGS. 6B and 7B, when the biomaterial 136 is less frequently adsorbed on the adsorption layer 140 for a certain period of time, the unit cells 110 may sense photons hν lower than those in FIG. 6A. Some of the photons hν may be absorbed to and reflected from the biomaterial 136, and the other photons hν may be sensed by the unit cells 110 after passing through the adsorption layer 140. The histogram in FIG. 7B may correspond to the number of the photons hν. From this, it may be understood that a biomaterial is adsorbed.

Referring to FIGS. 6C and 7C, when a large amount of a biomaterial 136 is adsorbed on the absorption layer 140, the unit cells 110 may sense a small amount of photons hν. Most of the photons hν may be absorbed to and reflected from the biomaterial 136. The histogram in FIG. 7C may correspond to the number of the photons hν. From this, it may be understood that a biomaterial is absorbed high.

As described with reference to FIGS. 6A to 6C and 7A and 7C, the intensity of transmitted light decreases as the amount of biomaterials increases. Thus, an optical signal goes to low. By using this characteristic, the biomaterial may be used as a biosensor. Although biomaterials fixed to an adsorption surface have uniform density, the intensity of transmitted light varies depending on biomaterials which are introduced and bound to each other. Thus, the fixed biomaterial may be used as a biosensor. When probe DNA is fixed to an adsorption surface, the light intensity varies depending on the amount of target DNA and depending on the amount of an antigen which is introduced to cause an antigen-antibody reaction to a fixed antibody. From this, the dynamic range of the biosensor may be set.

According to embodiments of the inventive concept, a biomaterial detection apparatus includes a light source, a substrate, a single photonic sensor layer, and an adsorption layer. The light source may provide a small amount of photons to the single photonic sensor layer. The single photonic sensor layer may sense photons. The adsorption layer may allow photons to pass therethrough. The adsorption layer may adsorb a biomaterial flowing between the light source and the substrate. The biomaterial may adsorb and reflect the photons. The photons pass through the adsorption layer may be output as a voltage signal amplified at the singe photonic sensor layer. The single photonic sensor layer may include an avalanche photodiode or silicon photomultiplier. Thus, the biomaterial detection apparatus may sense a small amount of photons to increase or maximize a receive sensitivity.

While the inventive concepts have been particularly shown and described with reference to exemplary embodiments thereof, it will be apparent to those of ordinary skill in the art that various changes in form and detail may be made therein without departing from the spirit and scope of the inventive concepts as defined by the following claims.

What is claimed is:

1. A biomaterial detection apparatus comprising:
a light source providing quantized photons;
a substrate spaced apart from the light source;
a single photonic sensor layer disposed on the substrate to sense the photons; and
an adsorption layer covering the single photonic sensor layer, allowing the photons to pass therethrough, and adsorbing a biomaterial between the light source and the substrate.

2. The biomaterial detection apparatus as set forth in claim 1, wherein the single photonic sensor layer comprises an avalanche photodiode or a silicon photomultiplier.

3. The biomaterial detection apparatus as set forth in claim 1, wherein the adsorption layer comprises silicon or silicon oxide.

4. The biomaterial detection apparatus as set forth in claim 1, wherein the adsorption layer comprises at least one of glass, quartz, silicon nitride (Si₃N₄), germanium nitride (Ge₃N₄), aluminum oxide (Al₂O₃), aluminum sulfide (Al₂S₃), gallium sulfide (Ga₂S₃), indium sulfide (In₂S₃), aluminum selenide (Al₂Se₃), gallium selenide (Ga₂Se₂), indium selenide (In₂Se₃), aluminum telluride (Al₂Te₃), gallium telluride (Ga₂Te₃), indium telluride (In₂Te₃), aluminum cobalt (Al₂CO), polycarbonate, poly(methyl methacrylate) (PMMA), and cyclic olefin copolymer (COC).

5. The biomaterial detection apparatus as set forth in claim 1, wherein the adsorption layer comprises a DNA adsorption layer.

6. The biomaterial detection apparatus as set forth in claim 5, wherein the DNA adsorption layer comprises thiol, amine or silane.

7. The biomaterial detection apparatus as set forth in claim 1, wherein the photons of the light source are controlled or modulated by an AC power source.

8. The biomaterial detection apparatus as set forth in claim 7, wherein the AC power source is a sine wave, a square wave or a pulse wave.

9. The biomaterial detection apparatus as set forth in claim 1, wherein the light source comprises a light emitting diode (LED) or laser.

10. The biomaterial detection apparatus as set forth in claim 1, further comprising:
a controller configured to count the number and frequency of the photons using a sensing signal output from the single photonic sensor layer according to the amount of the photons.

11. The biomaterial detection apparatus as set forth in claim 1, wherein the substrate comprises a semiconductor or a metal with conductivity.

12. A biosensor comprising:
a substrate;
a single photonic sensor layer disposed on the substrate to sense photons; and
an adsorption layer covering the single photonic sensor layer, allowing the photons to pass therethrough, and adsorbing a biomaterial to the substrate.

13. The biosensor as set forth in claim 12, wherein the adsorption layer comprises silicon or silicon oxide.

14. The biosensor as set forth in claim 13, wherein the adsorption layer comprises at least one of glass, quartz, silicon nitride (Si₃N₄), germanium nitride (Ge₃N₄), aluminum oxide (Al₂O₃), aluminum sulfide (Al₂S₃), gallium sulfide (Ga₂S₃), indium sulfide (In₂S₃), aluminum selenide (Al₂Se₃), gallium selenide (Ga₂Se₂), indium selenide (In₂Se₃), aluminum telluride (Al₂Te₃), gallium telluride (Ga₂Te₃), indium telluride (In₂Te₃), aluminum cobalt (Al₂CO), polycarbonate, poly(methyl methacrylate) (PMMA), and cyclic olefin copolymer (COC).

15. The biosensor as set forth in claim 12, wherein the adsorption layer comprises a DNA adsorption layer.

16. The biosensor as set forth in claim 15, wherein the DNA adsorption layer comprises thiol, amine or silane.
